(19) United States
(12) Patent Application Publication
(10) Pub. No.: US 2007/0135953 A1
(43) Pub. Date: Jun. 14, 2007

(54) Zipper speaker

(76) Inventor: Todd Crow, Draper, UT (US)

Correspondence Address: US CORPORATIONS, INC., P.O. BOX 234265, ENCINITAS, CA, 92023, US

(21) Appl. No.: 11/304,154

(22) Filed: Dec. 14, 2005

(51) Int. Cl. G06F 17/00; G10L 21/00

(52) U.S. Cl. 700/94; 381/124; 704/272

(57) ABSTRACT

A small electronic device that is either attached to or an integral part of a zipper pull tab that plays back sound when the pull tab is moved in either direction. The sound can be played back through the manual depression of a switch located on the device without moving the zipper pull-tab in either direction. The device is also capable of recording sound to be played back.

### FIELD OF THE INVENTION

This invention relates to the field of small, portable recording and playback devices. Specifically, this invention discloses a sound playback device that is located on the zipper pull-tab of an article of clothing. With this device, the user can record sounds or messages to be played back. Such recorded sounds can be used to entertain the user, the remind the user of something important or to warn the user or others of any dangers of which they should be aware.

### BACKGROUND OF THE INVENTION

In an increasingly technologically portable world, there are many gadgets that can remind a person of important tasks, such as memo recordings on cellular phones and hand-held personal computers. Of course, there is always the old fashioned way of written reminders. However, often, a person is not in a situation where her or she can practically use a cellular phone or a hand-held personal computer, such as while in remote areas. Similarly, it is not always feasible for a person to carry around a tape recorder or a memo pad to remind him of her of important facts or tasks. The current invention involves a device that can record sounds that can be played back to remind a person of important matters as well as other uses. The novelty and usefulness of the current invention involves the fact that the device is contained on an article of clothing of the user, i.e., a zipper pull-tab.

The device is a small electronic sound and recording device that can be attached to or become a permanently affixed and integral part of a zipper pull-tab. When the zipper is moved in either direction, a sound is played from the device. Alternatively, the sound can be triggered from a button located on the outside of the device without the need for the zipper be moved in any direction. Besides offering reminders to the user, the device can be used for entertainment. It can also be used as part of a warning system for the user as well as others.

### SUMMARY OF THE INVENTION

In the preferred embodiment of the invention, a small electronic device is either attached to or becomes a permanently affixed integral part of a zipper pull-tab. When the zipper is “zipped” or “unzipped”, i.e., whenever there is movement associated with the zipper, a sound will be played from the device. The sound can also be triggered from a button on the outer portion of the device.

The electronic device contains a small speaker, a portable power source, e.g., batteries, a circuit board, sufficient memory and the necessary components that will created an on/off switch or triggering mechanism. The zipper is part of an actual switch. When the device detects movement up or down, a sound is played. Sound can also be played by activating the switch manually, with no zipper movement. Sound can also be recorded into the device and stored for playback. The device is made of a durable material, such as metal or hard plastic and is approximately the size of four nickels laid flat, one on top of the next.

### OBJECT OF THE INVENTION

The principal object of the invention is to provide a means for sounds to be played back to a person who is wearing a garment that has a zipper, with the zipper pull tab playing back the sound when moved or when the switch is manually activated.

It is a further object of the invention to be able to record sounds for playback later.

### BRIEF DESCRIPTION OF THE DRAWINGS

FIG. 1 illustrates a front view of the device as it appears on a zipper pull-tab.

### DETAILED DESCRIPTION OF AN ENABLING AND PREFERRED EMBODIMENT

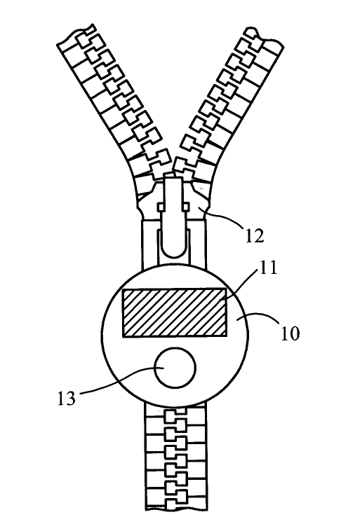

For a better understanding of the invention, we turn now to the drawings. FIG. 1 shows the device as it appears on a zipper pull-tab. The device 10 is attached to or permanently affixed to a zipper pull tab 12 and is enclosed in an outer encasing that is made of metal or hard plastic. The device 10 is about the size of four nickels stacked one on top of the next. Sound is played back through a speaker 11. The device is run by a power source (not shown), i.e., a small battery. A sufficient amount of memory and a circuit board allow for the recording and playback of sounds. A triggering means 13 activates the playback of sound either through movement of the zipper pull-tab 12 or by manual depression of the 25 triggering means 13, i.e., a small button.

The illustrations and examples provided herein are for explanatory purposes and are not intended to limit the scope of the appended claims, as those skilled in the art will make modifications to the invention for particular uses.

I claim:

1. A sound playback device that is attached to a common zipper pull-tab, said device comprising
an outer encasing;
a speaker;
a power source;
a circuit board;
memory;
a triggering means that activates the playback of sound, said triggering means being located on the outside of said outer encasing.

2. A sound playback device according to claim 1 wherein said power source is a small battery.

3. A sound playback device according to claim 1 wherein said outer encasing is made of metal.

4. A sound playback device according to claim 1 wherein said outer encasing is made of hard plastic.

5. A sound playback device according to claim 1 wherein said device contains a means for recording of the sounds to playback through said speaker.

6. A sound playback device according to claim 1 wherein said device is a permanently affixed part of said zipper pull-tab.

7. A sound playback device according to claim 1 wherein said triggering means is activated when the zipper pull tab is moved in either direction while opening or closing the zipper onto which said zipper pull tab is attached.

8. A sound playback device according to claim 1 wherein said triggering means is activated when said triggering means is manually depressed by the user without requiring that said zipper be moved in any direction.

9. A method for playing back recorded sound from a device that is attached to a common zipper pull-tab, said device comprising
an outer encasing;
a speaker;
a power source;
a circuit board;
memory;
a triggering means for activation of said device;
said method comprising the movement of said zipper pull-tab in either direction.

10. A method according to claim 9 wherein said power source is a small battery.

11. A method according to claim 9 wherein said outer encasing is made of metal.

12. A method according to claim 9 wherein said outer encasing is made of hard plastic.

13. A method according to claim 9 wherein said device contains a means to record the sounds to play back through said speaker.

14. A method according to claim 9 wherein said device is a permanently affixed part of said zipper pull-tab.

15. A method for playing back recorded sound from a device that is attached to a common zipper pull-tab, said device comprising
an outer encasing;
a speaker;
a power source;
a circuit board;
memory;
a triggering means for activation of said device;
said method comprising the manual depression by the user of said triggering means without requiring that said zipper be moved in any direction.

16. A method according to claim 15 wherein said power source is a small battery.

17. A method according to claim 15 wherein said outer encasing is made of metal.

18. A method according to claim 15 wherein said outer encasing is made of hard plastic.

19. A method according to claim 15 wherein said device contains a means to record the sounds to play back through said speaker.

20. A method according to claim 15 wherein said device is a permanently affixed part of said zipper pull-tab.
